(19) United States
(12) Patent Application Publication
(10) Pub. No.: US 2024/0278467 A1
(43) Pub. Date: Aug. 22, 2024

(54) MOLD OF A FORMING TOOL, FORMING TOOL, AND METHOD FOR DEMOLDING

(71) Applicant: Airbus Operations GmbH, HAMBURG (DE)

(72) Inventors: Pascal STROH, HAMBURG (DE); Felix MARQUARD, HAMBURG (DE)

(21) Appl. No.: 18/437,573

(22) Filed: Feb. 9, 2024

(30) Foreign Application Priority Data
Feb. 17, 2023 (EP) 23157344.5

(51) Int. Cl. B29C 45/40; B29C 45/02; B29C 45/26

(52) U.S. Cl. CPC B29C 45/4005; B29C 45/02; B29C 45/2602; B29C 2045/4068

(57) ABSTRACT

A mold of a forming tool capable to be used for resin transfer molding processes or injecting molding processes, wherein an inner surface of the mold, which is adapted to limit on one side a forming tool cavity for a product to be fabricated, has an integral surface section which is adapted be moved relatively to adjacent surface areas in a demolding direction. Also a forming tool having such a mold and a method for demolding in which an integral inner surface section acts as membrane and is moved inside the cavity to push the product out of the mold.

### CROSS-REFERENCES TO RELATED APPLICATIONS

This application claims the benefit of European Patent Application Number 23 157 344.5 filed on Feb. 17, 2023, the entire disclosure of which is incorporated herein by way of reference.

### FIELD OF THE INVENTION

The present invention concerns a mold of a forming tool, in particular for a forming tool capable to be used for resin transfer molding processes or for injection molding processes, such a forming tool and a method for demolding, in particular for demolding a fabricated product from a mold of a forming tool.

### BACKGROUND OF THE INVENTION

Knowing forming tools for resin transfer molding processes (RTM) or for injection molding processes comprise in general a lower mold and an upper mold. The molds define a cavity prepared for receiving a product to be produced. In order to put parts such as preforms which are needed for the fabrication of the product in the cavity and in order to release the fabricated product out of the cavity, the cavity can be opened by lifted up the upper mold from the lower mold. For demolding, in particular to overcome (loose) any adhesion between the lower mold and the fabricated product, at least one ejector means is provided in the lower mold. As shown in DE 10 2011 050 976 A1, the ejector means comprises a plurality of metallic pistons which can be moved upwards so that the fabricated product is lifted up and thus pushed of the lower mold. The pistons are positioned in holes of the lower mold in such a way that their front surfaces form a surface section of an inner surface of the lower mold that defines a bottom of the cavity. In a retracted state their front surfaces are flush with adjacent surface areas of the inner surface. In order to avoid any turning of the pistons in the holes, they are locked against turning.

DE 10 2013 207 668 A1 shows forming tool whose at least one metallic ejector piston is guided in a ventilation hole of a lower mold. The ventilation hole is opened to an inner surface of the lower mold and connected to a ventilation line. By moving the piston, a fabricated product can be lifted and in addition, the piston can be used for blocking the ventilation line.

In order to avoid that resin gets between the retracted piston and the tool, the pistons are sealed. With low-viscous resin a small amount of resin will always pass this sealing and over time the piston will get stuck due to cured resin leftovers.

In DE 10 2014 005 629 B4 a forming tool is shown using an elastomeric membrane that is inserted into the lower mold. However, the transitions from the membrane to the lower mold can create an unavoidable bead in the product which prevents production of a so-called class A surface. In addition, an elastomer has a worse and uneven thermal conductivity compared to metallic ejector means.

### SUMMARY OF THE INVENTION

It is an object of the present invention to provide a simplified alternative mold of a forming tool, in particular for a forming tool capable to be used for resin transfer molding processes or for injection molding processes, to propose an improved forming tool and to propose an improved method for demolding.

The object may be achieved by a mold with the features of one or more embodiments herein, by a forming with the features of one or more embodiments herein, and by a method with the features of one or more embodiments herein. Advantageous embodiments are also disclosed.

According to the invention, a mold of a forming tool, in particular for a forming tool capable to be used for resin transfer molding processes or injecting molding processes, is provided. The mold is adapted to act together with another mold of the forming tool in order to form a cavity for a product to be fabricated, wherein by its inner surface the mold limits on one side the cavity. The inner surface of the mold has an integral surface section which is adapted be moved relatively to adjacent surface areas in a demolding direction.

If the inventive mold is a lower mold of the forming tool, the mold is adapted to form a bottom of the cavity by its inner surface. If the inventive mold is an upper mold, the mold is adapted to form a ceiling of the cavity by its inner surface. The integral surface section is not a separate part that has been produced separately from the mold and connected to it later after its production. The integral, preferable seamless transition between the movable surface section and the surrounding inner surface areas avoids any beading or surface unevenness. Looking at the inner surface of the mold from the top, the integral surface section is basically not visible. Thus, the production of a Class A surface is possible. In addition, thermal problems do not occur as the movable surface section and the surrounding inner surface areas consists of the same material. In particular, the inventive mold can be implemented in large forming tools for the production of fiber reinforced plastics using low viscous resin enabling a class A surface without markings due to the inventive demolding. However, the inventive mold is not limited to any size of a forming tool. It can also be used for small or middle-sized forming tools.

Preferably, the integral surface section is material reduced compared to the adjacent surface areas in demolding direction. The surface section acts as a metallic membrane that is thin enough to show elastic behavior. For instance, when the surface section has a rectangular shape with the dimensions of 1 mm×208 mm×104 mm (thickness×long-side×short-side) and consists of metal (steel), it can roughly be lifted elastically up to 6.5 mm, without showing any plastic deformation. It is noted that the shape of the surface section is not limited to a rectangular shape. Alternative shapes such as circular shapes, oval shape, star shape, etc. are also applicable. Preferably, the shape of the surface section is orientated to the shape of the mold.

In order to avoid any bending in a counter direction of the surface section due to stress caused by injection pressure during processing of the product, a support element can be provided under the surface section in order to support the surface section during processing. Otherwise the surface section could deform in the counter direction and the mold couldn't maintain its designated geometry. Preferably, the support element has the same size as a pocket under the surface section, which was created by removing the material in order to create the surface section (membrane). Thus, in a not detached state, the surface section rests with its entire extension on the support element. In addition, it is preferred if the support element and the integral surface are made from the same metallic material, thus a material's behavior with respect to heat transfer is as uniform as possible.

Preferably, the integral surface section (membrane) is moved in demolding direction by at least one ejector means. In order to position the ejector means, for instance a piston, a recess can be provided in the support element. The ejector means can be driven hydraulically, pneumatically or mechanically, for instance. Thus, the support element fulfils two main functions: First, it supports the thin surface section during processing, and second, it houses and guides the at least one ejector means. Alternatively, the support element itself can be moved in demolding direction and thus acting as ejector means. In its retracted state, the ejector means is flush with a support surface of the support element. When the ejector means is actuated in demolding direction, it pushes against the surface section (membrane). As a consequence of the demolding stroke, the metal membrane deforms elastically and pushes the product out of the mold to such an extent that any adhesive connection to the inner surface of the mold surface is detached and demolding is facilitated. In one example, the at least ejector means can be moved about 5-6 mm in demolding direction. In general, the maximum demolding stroke depends on the thickness, the size and the shape of the surface section. In addition, the maximum stroke is influenced by the position of the ejector means in relation to the surface section, that means where the ejector means contacts the surface section from the back.

In order to distribute evenly the pressure force (force needed to move the surface section in the demolding direction), it is preferred if the upper recess is positioned in such a manner in the support element that it can be positioned in the middle (center) of the surface section. If only one support element is provided in the mold, the surface section is positioned in the middle (center) of the inner surface of the mold. If a plurality of surface sections is provided, they are distributed evenly over the entire inner surface of the mold.

The at least one ejector means needs energy to be activated. Thus, supply lines, for instance a hydraulic line, are provided. Therefore, it is preferred if the support element has in addition to at least one support portion at least one supply portion. The supply portion provides internally all required supply lines. The required supply lines extend between the upper recess in the support portion and an outer supply connection area (coupling area) of the supply element.

In order to position the support element adequately in the mold, in a bottom side of the mold a recess can be provided. The recess is adapted to receive the supply portion of the support element and has the same or almost the same length as the supply portion, so that the outer supply connection area is at least almost flush with a side wall of the mold. By means of this, no supply lines are needed in the mold itself as all required supply lines for the at least ejector means run through the support element. In particular, in the unlikely event of a damage of the coupling between the connection area and an external coupling member, the coupling can be easily repaired as it accessible from the outside. However, it is also possible to provide the connecting area at the support portion. In such a case, pipes or tubes could be used as necessary supply lines.

According to the invention, a forming tool in particular a forming tool capable to be used for resin transfer molding processes or injecting molding processes comprises an inventive mold.

The forming tool can be used for the production of fiber reinforced plastics using low viscous resin enabling a class A surface without markings due to the demolding technology, for instance.

According to the invention, a method for demolding, in particular for detaching a fabricated product out of a mold of a forming tool, in particular a forming tool capable to be used for resin transfer molding processes or injecting molding processes, wherein an inner surface of the mold limits on one side a cavity in which the product is fabricated, comprises the step that an integral surface section of the inner surface of the mold is moved relatively to adjacent surface areas in demolding direction by a force acting from the back on the integral surface section.

The method takes advantage of the fact that even a metallic surface section can be deformed elastically if it has a membrane-line thickness. Thereby, the elastic character depends on the thickness, the material and the size of the surface section. The method can be implemented in large as well as in small and medium forming tools for the production of fiber reinforced plastics using low viscous resin enabling a class A surface without markings due to the inventive demolding. It is used at the end of a RTM production process when the product needs to be pushed out of the mold.

### BRIEF DESCRIPTION OF THE DRAWINGS

In what follows, a preferred embodiment of the present invention is explained with respect to the accompanying drawings. As is to be understood, the various elements, components and geometrical structures are depicted as examples only, may be facultative and/or combined on a manner different than depicted. Reference signs for related elements are used comprehensively and not defined again for each figure. Shown schematically in:

FIG. 1 is an explosive view of an exemplary forming tool according to the invention;

FIG. 2 is a perspective view of an inventive support element;

FIG. 3 is a perspective view of an inventive ejector piston;

FIG. 4a is a detailed top view of the inventive mold shown in FIG. 1;

FIG. 4b is a detailed side view of the inventive mold shown in FIG. 1;

FIG. 5a is a detailed top view of the support element shown in FIG. 2;

FIG. 5b is a detailed side cross-section view of the support element shown in FIG. 2;

FIG. 6 is a side, cross-section view of the assembled mold;

FIG. 7a is a detailed top view of the ejector piston shown in FIG. 3; and,

FIG. 7b is a side view of the ejector piston shown in FIG. 3.

### DETAILED DESCRIPTION OF THE PREFERRED EMBODIMENTS

In FIG. 1 a preferred embodiment of an inventive forming tool 1 is shown. The forming tool 1 can be used for the production of fiber reinforced plastics using low viscous resin enabling a class A surface without markings due to the inventive demolding technology. An exemplary production method is resin transfer molding (RTM).

The forming tool 1 comprises at least an inventive lower mold 4 that acts together with an upper mold 6. Both molds 4, 6 are orientated horizontally (in general) and define a cavity in which the product 2 is fabricated. In the shown embodiment, the product 2 is a spineboard.

The cavity is limited by inner surfaces 8, 10 of the lower mold 4 and the upper mold 4. The inner surfaces 8, 10 are facing each other so that the inner surface 8 of the lower mold 4 forms a bottom of the cavity and the inner surface 10 of the upper mold 6 forms a ceiling of the cavity. The cavity can be opened and closed by moving the upper mold 6 upwards in vertical direction.

Further on, in the shown embodiment the forming tool 1 has a lower base plate 12, a sprue block 14, and an upper base plate 16. The positioning and usage of these elements are common, so that a detailed description can be omitted. Further on, the forming tool 1, in particular their elements (4, 6, 12, 14, 16) comprise known supply lines such as, resin injection lines, evacuation lines, ventilation lines, sealings, etc., which are necessary for RTM-processing.

According to the invention the inner surface 8 of the lower mold 4 has an integral surface section 18 which is adapted be moved relatively to adjacent surface areas 20 in a demolding direction z, which is in the shown embodiment in vertical direction from bottom to top. In FIG. 1, the integral surface section 18 is highlighted by a dash circle, as it is not visible from the top. In the following the term “lifting direction z” is also used for “demolding direction z”. By means of pushing the integral surface section 18 upwards, any adhesion between the fabricated product 2 and the inner surface 8 is released such that the fabricated product 2 can be taken out easily of the opened cavity from the lower mold 4. If the inventive mold is the upper mold 6, the term “lifting direction z” will also be adequate, as then the demolding movement of the product 2 will show away from the inner surface 10 of the upper mold 6, in particular downwards, so that the product 2 will be “lifted down” and pushed out of the upper mold 6.

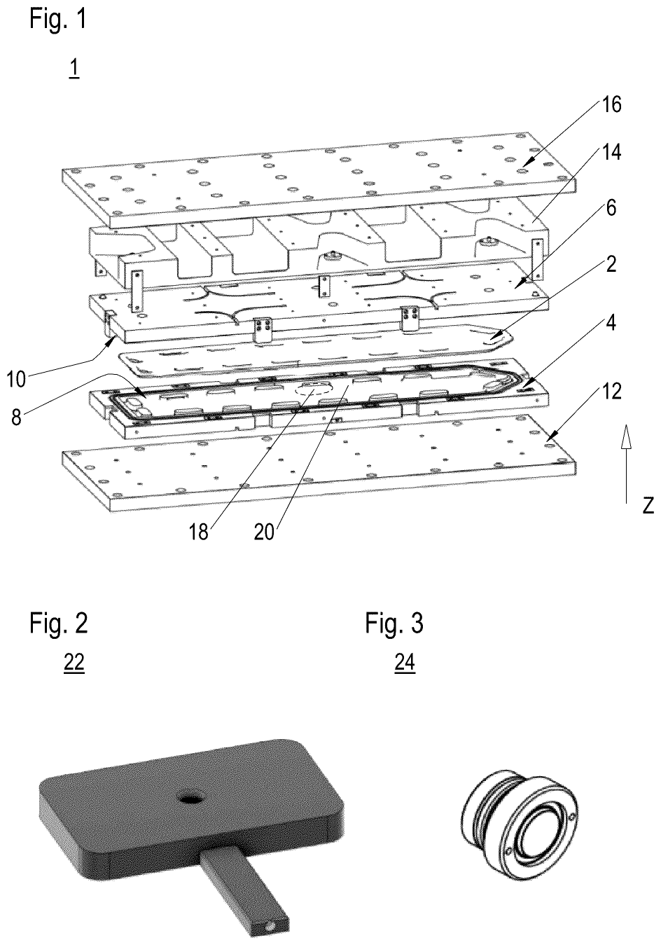

Below the integral surface section 18, a support element 22, shown in FIG. 2, is positioned. The support element 22 acts as a rest block and avoids any deformation of the integral surface section 18 caused by stress and pressure acting on the product 2 during fabrication. In addition, the support element 22 houses an ejector piston 24 shown in FIG. 3.

The ejector piston 24 is adapted to push the integral surface section 18 in lifting direction z during demolding.

The integral surface section 18, the support element 22 and the piston 24 will be descripted in more detailed in the following figures.

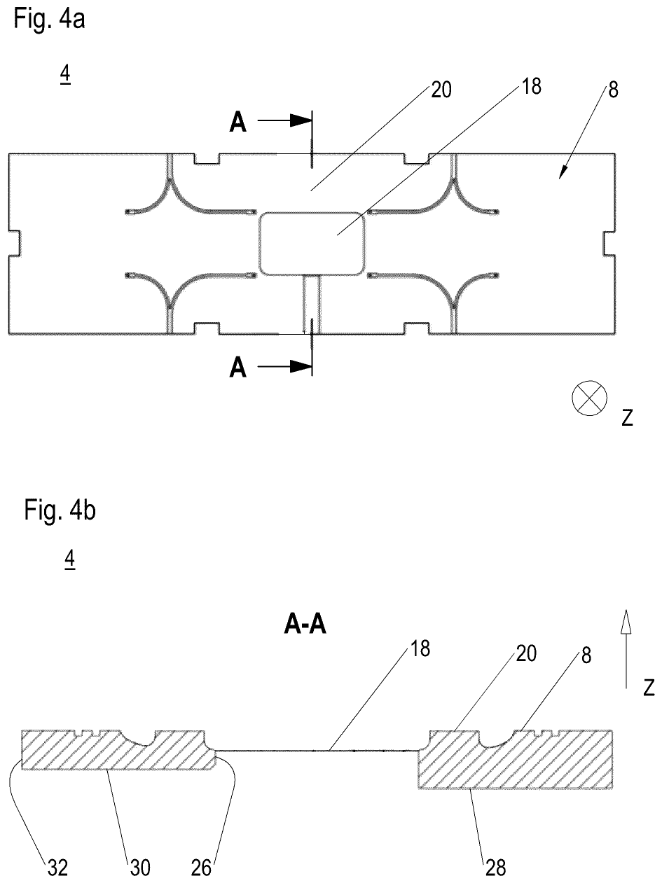

As exemplary shown in the bottom view of the lower mold 4 according to FIG. 4a and in the cross-section according to FIG. 4b, the integral surface section 18 has a rectangular shape. It is positioned in the middle of the lower mold 4 so that lifting forces are acting evenly on the product 2 to be demolded.

The integral surface section 18 is made by material reduction of the lower mold 4 such that a pocket 26 is established which is opened to the bottom side 28 (outer surface which is opposite to the inner surface 8) of the lower mold 4 but closed to upper side (inner surface 8) of the lower mold 4 by the surface sections 18. In a preferred embodiment, when the lower mold 4 is metallic, the material reduction can be released by milling.

The surface section 18 is integrally formed with the surrounding areas 20 of the inner surface 8. This means that the surface section 18 is seamless integrated into the inner surface 8. Looking form above on the lower mold 4, the surface section 18 cannot be seen due to their seamless integration. The surface section 18 consists of the same material as the surface of the surrounding areas 20. The only difference between the surface section 18 and the surrounding surface areas 20 is that the surface section 18 is material reduced from the back in such a manner that it (the surface section 18) shows elastics characteristics enabling its lifting up relatively to the rigid surrounding surface areas 20. In other words, the integral surface section 18 forms an elastic (flexible), seamless integrated membrane that consists of the same material as its surrounding surface areas 20.

It is important that the membrane formed by the surface section 18 deforms only on an elastic basis of the metal when the ejector piston 24 executes a lifting stroke (demolding stroke). During the lifting stroke, the surface section 18 only stretches to that extend that the elasticity remains securely within its elastic range.

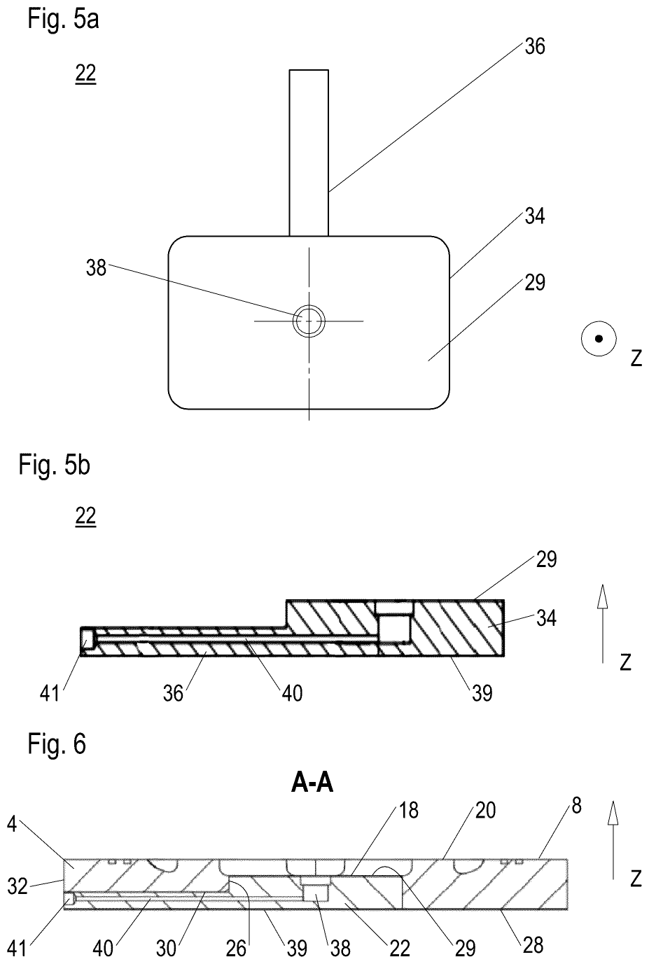

The maximum lifting stroke, which is the lifting stroke after which plastic deformation of the surface section 18 occurs, can be calculated by Hooke's calculation ε=σ/E, and the Theorem of Pythagoras a²+b²=c². In order to avoid than any plastic deformation of the surface section 18, it is recommended to select an ejector piston 24 having a smaller maximum lifting stroke if positioned in the support element 22 and measured from surface 29 (support surface of the support element 22, shown in FIGS. 5a, 5b and 6) on which the surface section 18 rests during fabrication.

In addition, in the bottom side 28 of the lower mold 4 a channel 30 is provided. The channel 30 is opened at its ends and over its entire length to the bottom side 28. It extends between the pocket 26 and a side wall 32 of the lower mold 4.

The channel 30 has a straight shape and has a smaller height than the pocket 26. It is a kind of straight recess which can be manufactured by milling as well.

In FIGS. 5a and 5b the exemplary support element 22 is shown in more detail. Preferably, the support element 22 is made of the same material as the lower mold 4. It has a support portion 34 and a supply portion 36. The support portion 34 provides the support surface 29 and has a rectangular shape. In particular, the dimensions are such that it fits perfectly in the pocket 26 of the lower mold 4 (see FIG. 6). That means, the surface section 18 is fully supported by the support portion 34 during fabrication so that any deformation of the surface section 18 to the underside of the lower mold 4 caused by stress or pressure acting on the product 2 is prevented. The height of the support element 22 is equal to the height of the lower pocket 26, so that height compensation is not necessary if the support element 18 is introduced and the lower mold 4 rests on the lower base plate 12.

In the middle of the support surface 29 of the support portion 34 an upper recess 38 is provided. The upper recess 38 is used for housing and guiding the ejector piston 24. The upper recess 38 has a circular shape that correspondence to the outer shape of the ejector piston 24. It is opened to the support surface 29 and at its bottom opened to a supply line 40. As the upper recess 38 is positioned in the middle of the support surface 29, the ejector piston 24 will be positioned in the middle (center) of the surface section 18 so that a lifting force is distributed evenly over the surface section 18. If as in the shown embodiment the surface section 18 is in the middle of the lower mold 4, the lifting force will be distributed not only evenly with respect to the surface section 18, but also with respect to the entire product 2.

The supply portion 36 of the support element 22 has a longitudinal arm-like shape. Looking from the side, both portions 34, 36 has the same bottom line 39, whereas the supply portion 36 has a smaller height than the support portion 34. The shape of the supply portion 36 corresponds to the shape of the channel 30 so that it fits perfectly in it (see FIG. 6). In particular both the supply portion 36 and the channel 30 has almost the same length.

The supply portion 36 provides the at least one supply line 40 that extends from the upper recess 38 to an outer connection area 41 in order to connect the at least one supply line to an energy source. If the ejector piston 24 is a hydraulic piston, for instance, the at least supply line 40 is used to feed hydraulic oil provided by an hydraulic system to the ejector piston 24 in order to lift the surface section 18 and to return the hydraulic oil back to the hydraulic system.

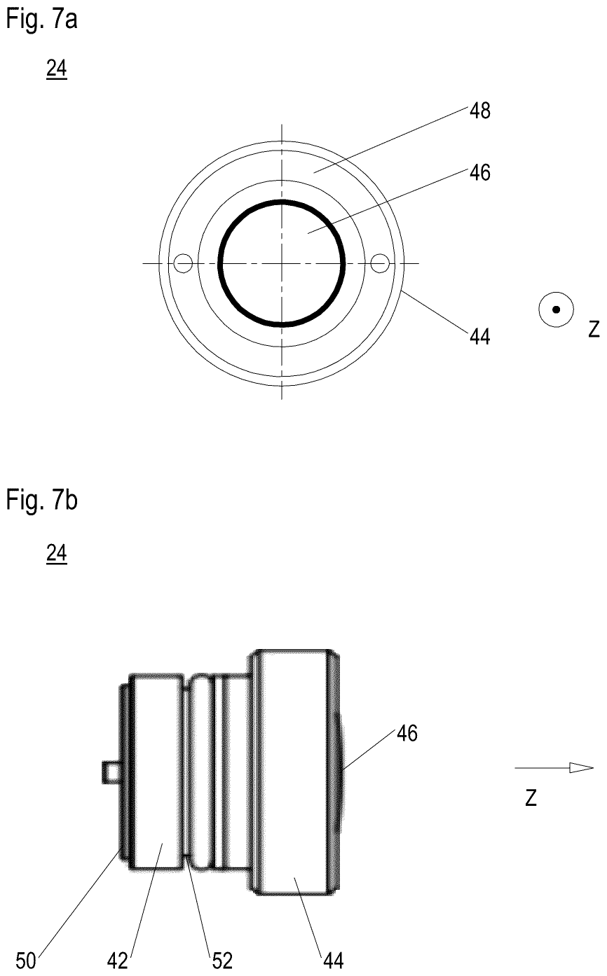

In FIGS. 7a and 7b an exemplary ejector piston 24 is shown. The piston has basically a cylindrical shape with a shaft 42 and a head 44 which is radially enlarged compared to the shaft 42. Its outer shape fits perfectly to the upper recess 38 of the support portion 34 of the support element 22. In order to optimize the transmission of the lifting force into the integral surface section 18, the front of the head 44 has a middle surface 46 which is slightly convex outward and surrounded by a flat annular surface 48.

The ejector piston 24 is pushed upwards by the hydraulic pressure acting on its back side 50. In order to avoid any leakage, at least one not shown seal ring is inserted in an annular groove 52 of the shaft 42.

According to an inventive method, in order to demold a fabricated product 2, the integral surface section 18 of the inner surface 8 of the lower mold 4 is moved relatively to the adjacent surface areas 20 in lifting direction by a lifting force acting from below on the integral surface section 18. The lifting force and in particular the stroke is applied in such a manner that the integral surface section 18 deforms only elastically, so that after the stroke is terminated, the surface section 18 goes back in its initial position, where it in surface contact with the support portion 34 of the support element 22.

Disclosed are a mold of a forming tool, in particular for a forming tool capable to be used for resin transfer molding processes or injecting molding processes, wherein an inner surface of the mold which (the inner surface) is adapted to limit on one side a forming tool cavity for a product to be fabricated has an integral surface section which is adapted be moved relatively to adjacent surface areas in a demolding direction, forming tool having such a mold and a method for demolding, wherein an integral inner surface section acts as membrane and is moved inside the cavity to push the product out of the mold.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCES

1 forming tool
2 product
4 lower mold
6 upper mold
8 inner surface of the lower mold
10 inner surface of the upper mold
12 lower base plate
14 sprue block
16 upper base plate
18 integral surface section (membrane)
20 adjacent/surrounding surface areas
22 support element
24 ejector piston
26 pocket
28 bottom side
29 support surface
30 channel
32 side wall of the lower mold
34 support portion
36 supply portion
38 upper recess
39 bottom line
40 supply line
41 outer connection area
42 shaft
44 head
46 middle surface
48 annular surface
50 back side
52 annular groove
z demolding/lifting direction

Claimed is:

1. A mold of a forming tool configured to be used for resin transfer molding processes or injecting molding processes, wherein the mold is configured to act together with another mold of the forming tool in order to form a cavity for a product to be fabricated,
wherein the mold limits on one side the cavity with an inner surface, the inner surface comprising an integral surface section which is configured be moved relatively to adjacent surface areas in a demolding direction.

2. The mold according to claim 1, wherein in the demolding direction the integral surface section is material reduced compared to the adjacent surface areas.

3. The mold according to claim 1, wherein a support element is provided under the integral surface section in order to support the surface section during processing.

4. The mold according to claim 3, wherein the support element has an upper recess for an ejector means.

5. The mold according to claim 4, wherein the upper recess is configured such that, in the support element, the upper recess is in a middle of the surface section.

6. The mold according to claim 4, wherein the support element has at least one support portion and at least one supply portion which is material reduced compared to the support portion and in which all required supply lines are provided internally extending between the upper recess in the support portion and an outer supply connection area of the support element.

7. The mold according to claim 6, further comprising:
a channel configured to receive the supply portion of the support element and having a length equal to the supply portion.

8. A forming tool comprising:
the mold according to claim 1.

9. A method for demolding a fabricated product from a mold of a forming tool, wherein an inner surface of the mold limits on one side a cavity in which the fabricated product is fabricated, the method comprising:
moving an integral surface section of the inner surface of the mold, relative to adjacent surface areas, in a demolding direction by a force acting from a back on the integral surface section.
